(19) United States
(12) Patent Application Publication
(10) Pub. No.: US 2008/0184544 A1
(43) Pub. Date: Aug. 7, 2008

(54) HEMMING PROCESSING METHOD AND HEMMING PROCESSING APPARATUS

(75) Inventors: Eisaku Hasegawa, Tochigi (JP); Yoshiyuki Kinouchi, Tochigi (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 12/026,988

(22) Filed: Feb. 6, 2008

(30) Foreign Application Priority Data
Feb. 7, 2007 (JP) 2007-028546

(51) Int. Cl. B23P 11/00; B21B 23/00

(52) U.S. Cl. 29/243.57; 72/366.2; 29/243.5

(57) ABSTRACT

A hemming processing apparatus (10a, 10b) is provided with a hemming roller (30), a roller moving apparatus (74), a movable mold (18), and a mold moving apparatus (72). The roller moving apparatus (74) moves the hemming roller (30) on a flange (17) of a work (12). The movable mold (18) supports the work (12). The mold moving apparatus (72) adjusts a direction of the movable mold (18) in accordance with a movement of the hemming roller (30).

This application claims foreign priority from Japanese Patent Application No. 2007-028546 filed on Feb. 7, 2007, the entire contents of which are hereby incorporated by reference.

### BACKGROUND OF THE INVENTION

1. Field of the Invention

The present invention relates to a hemming processing method and a hemming processing apparatus for bending a flange provided at the end portion of a work along a movable mold.

2. Related Art

As to edge portions of the bonnet, trunk, door and wheel housing of an automobile, a hemming processing is sometimes performed in a manner that a flange formed by erecting an edge portion of a panel is bent to the inward direction of the panel.

As an example of the hemming processing, there is a roll hemming processing in which the panel is positioned and held on a fixed mold and a roller is pushed to the flange at an end portion of the panel thereby to bend the flange. In the roll hemming processing, since a bending angle is large, the hemming processing is performed through a plurality of stages of processings including a preliminary bending (or preliminary hemming) and a finish bending (or main hemming) in view of a bending accuracy.

As an example of such roll hemming processing, there is proposed a method in which a work is set at a fixed mold provided for a dedicated process in a dedicated space and a unit held at the tip end of a robot is rolled along a flange thereby to perform the roll hemming (see a patent document 1 and a patent document 2, for example). In this method, the processing is performed in a state that the work is placed on the upper surface of the large fixed mold.

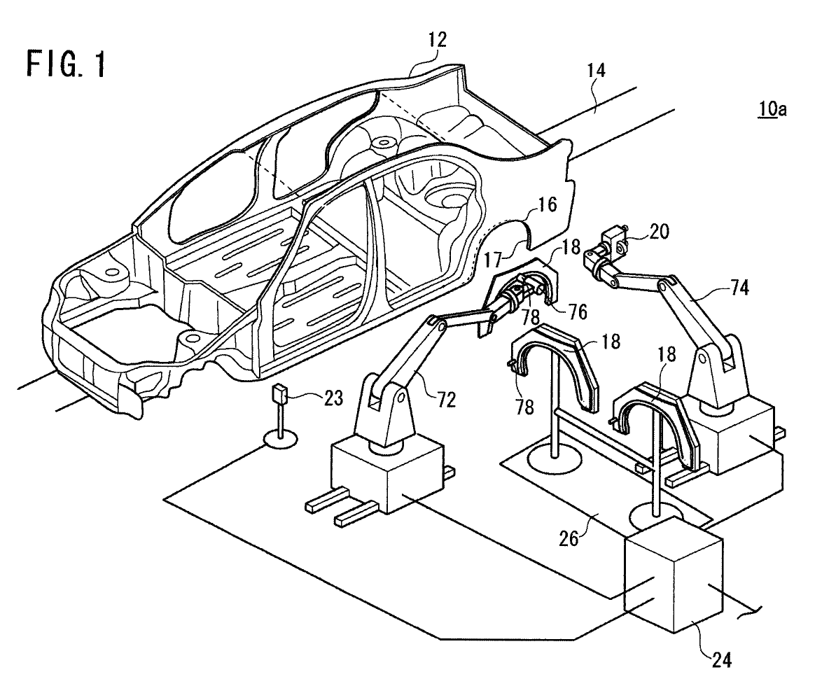

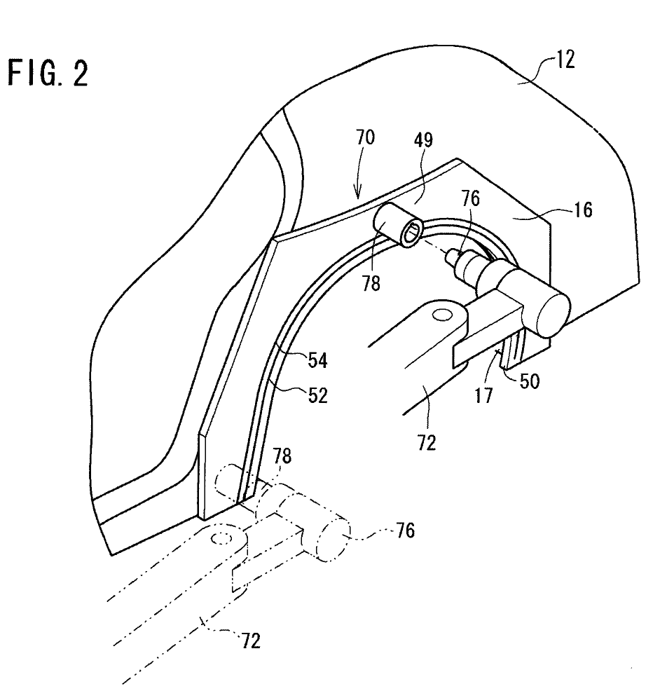

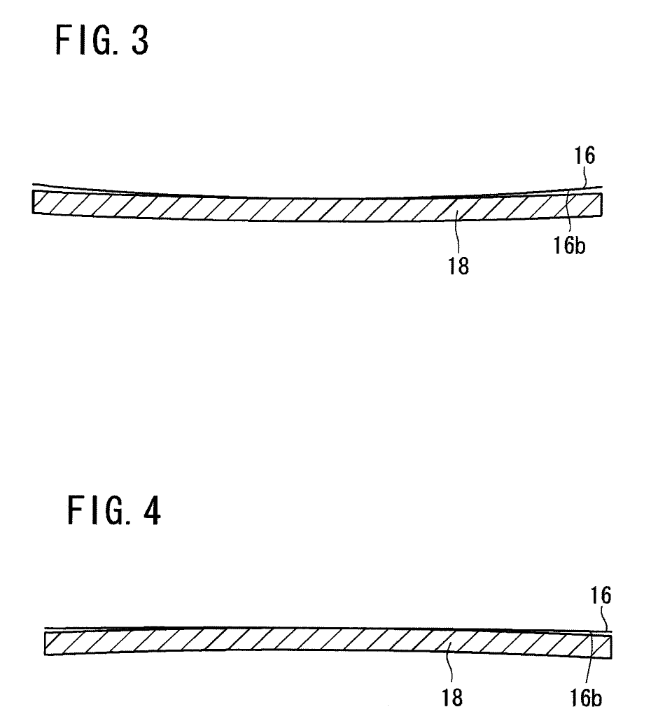

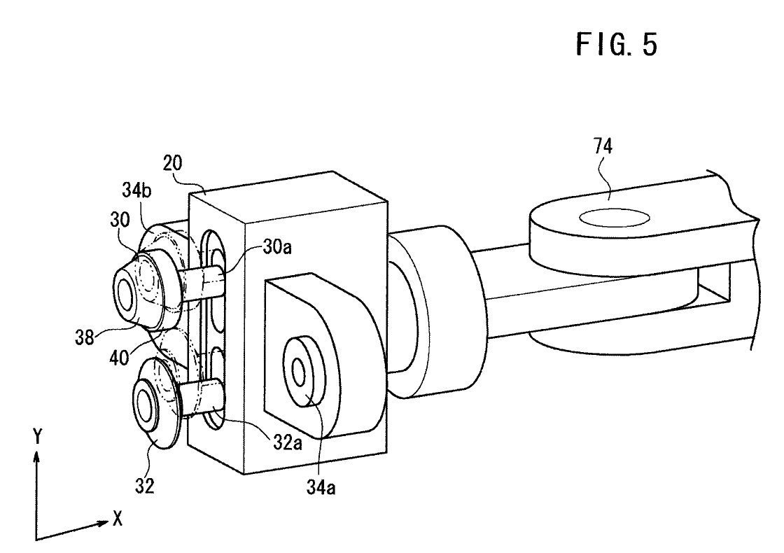

A flanging apparatus described in a patent document 3 proposes a method in which, in a state where a thin and elongated protection strip corresponding to a movable mold is abutted against a rim strip at the end portion of a work, a pushing roller is pressed against the rim strip while rolling a pressure roller against the protection strip thereby to perform the hemming processing in a sandwich manner.
[Patent Document 1] JP-Y2-2561596 (see FIGS. 2 and 5)
[Patent Document 2] JP-B2-2924569 (FIG. 3(c))
[Patent Document 3] JP-A-2006-110628 (FIGS. 1 and 3)

Desirably, the shape of a work is formed so as to match to the shape of a movable mold without any error. When a work is a sheet of panel member like a door panel or a bonnet, the error hardly occurs since the number of processing portions is small. On the other hand, when a work has a box configuration etc. like a white body which is formed by welding a plurality of sheet members, the work deforms due to heat of the welding and so there may arise a gap between the work and the movable mold.

Even if there arises a gap between the work and the movable mold, when the work is a sheet of panel member, the panel member temporarily bends along the shape of the movable mold when a roller rolls against panel member. Thus, a portion subjected to the hemming processing can be bent suitably.

However, when a work has the box configuration etc., since the work has high rigidity and so does not bend, the movable mold does not act effectively at the gap portion. Thus, there arises a fear that appear at the portion subjected to the hemming processing. Further, when the pressing force of the roller is raised excessively in order to eliminate the gap, the work is warped.

### SUMMARY OF THE INVENTION

One or more embodiments of the invention provide a hemming processing method and a hemming processing apparatus which can surely abut a movable mold against a work, can bend a portion subjected to the hemming processing so as to have a suitable shape and can prevent the warp and/or deformation of the work.

In accordance with one or more embodiment of the invention, a hemming method is provided with the steps of: using a hemming roller for bending a flange of a work to perform a hemming process, a movable mold for supporting the work, and a mold moving apparatus for moving the movable mold; and sandwiching the work between the hemming roller and the movable mold while adjusting a direction of the movable mold by the mold moving apparatus thereby to perform the hemming process as to the flange.

Moreover, in accordance with one or more embodiments of the invention, a hemming processing apparatus is provided with: a hemming roller; a roller moving apparatus for rolling the hemming roller on a flange of a work; a movable mold for supporting the work; and a mold moving apparatus for adjusting a direction of the movable mold in accordance with rolling of the roller.

In this manner, according to the embodiments, when the hemming operation is performed, the mold moving apparatus adjusts the direction of the movable mold so that the movable mold supports the work at the rolling portion of the hemming roller. Thus, the portion of the work applied with a force from the hemming roller abuts against the movable mold thereby to bend and process the hemming portion in a suitable shape and so the warp and deformation of the work can be prevented.

Further, the mold moving apparatus may include a multi-joint robot capable of being operated in accordance with a program. Thus, the positioning between the work and the movable mold can be performed quickly and accurately.

The mold moving apparatus may be operated in synchronism with the roller moving apparatus for moving the hemming roller thereby to adjust the direction of the movable mold. Thus, the mold moving apparatus acts actively, whereby the pressed portion by the hemming roller can be abutted against the movable mold more surely.

Furthermore, in accordance with one or more embodiments of the invention, a hemming processing apparatus is provided with: a hemming roller; a roller moving apparatus for rolling the hemming roller on a flange of a work; a movable mold for supporting the work; and a mold moving apparatus for holding the movable mold via an elastic member so that a direction of the movable mold can be adjusted in accordance with rolling of the roller. Thus, the elastic member deforms elastically by the pressing force from the hemming roller and so the mold moving apparatus acts passively, whereby the pressed portion by the hemming roller can be abutted against the movable mold more surely.

According to the embodiments, when the hemming operation is performed, the mold moving apparatus adjusts the direction of the movable mold so that the movable mold supports the work at the rolling portion of the hemming roller. Thus, the portion of the work applied with a force from the hemming roller abuts against the movable mold thereby to bend and process the hemming portion in a suitable shape and so the warp and deformation of the work can be prevented.

Other aspects and advantages of the invention will be apparent from the following description and the appended claims.

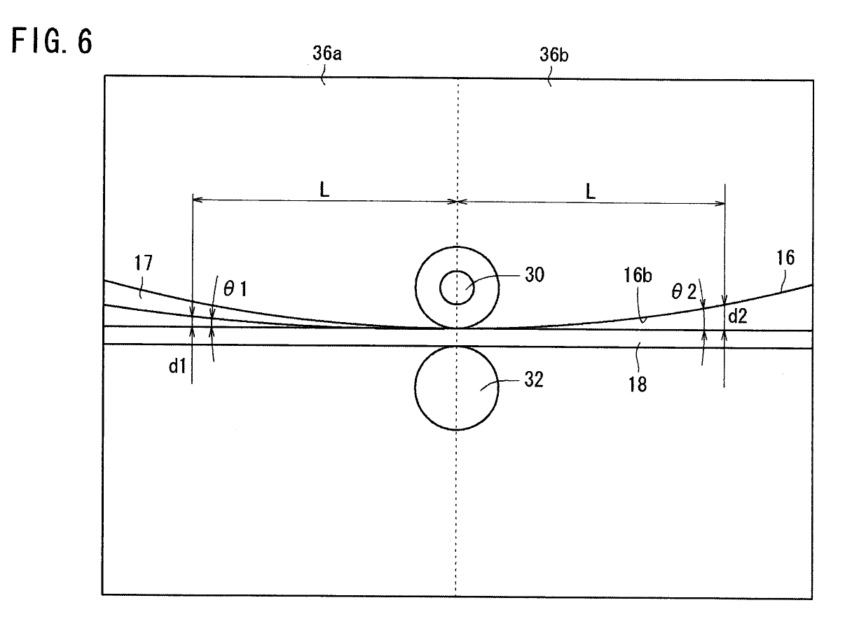

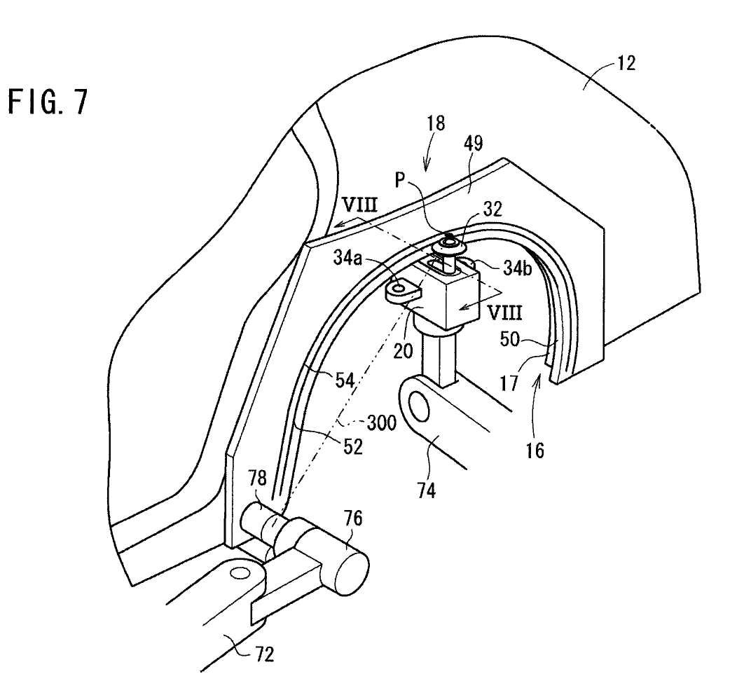

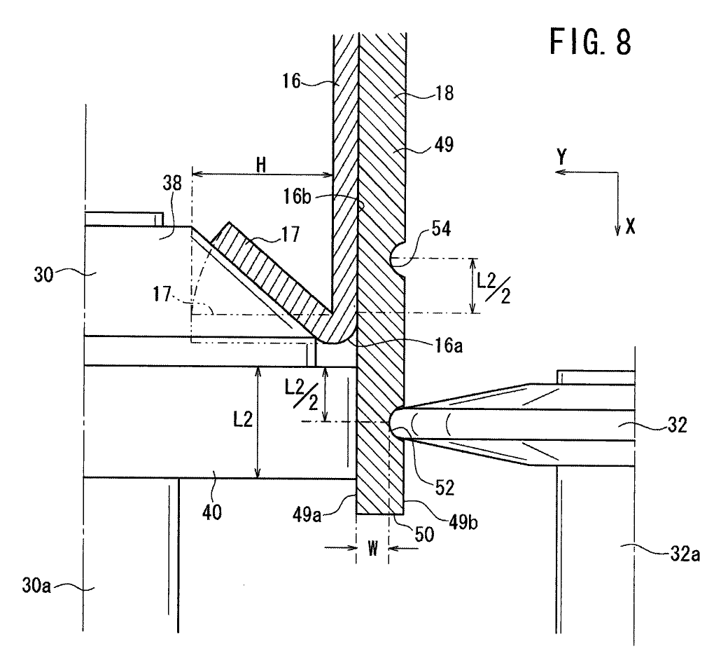

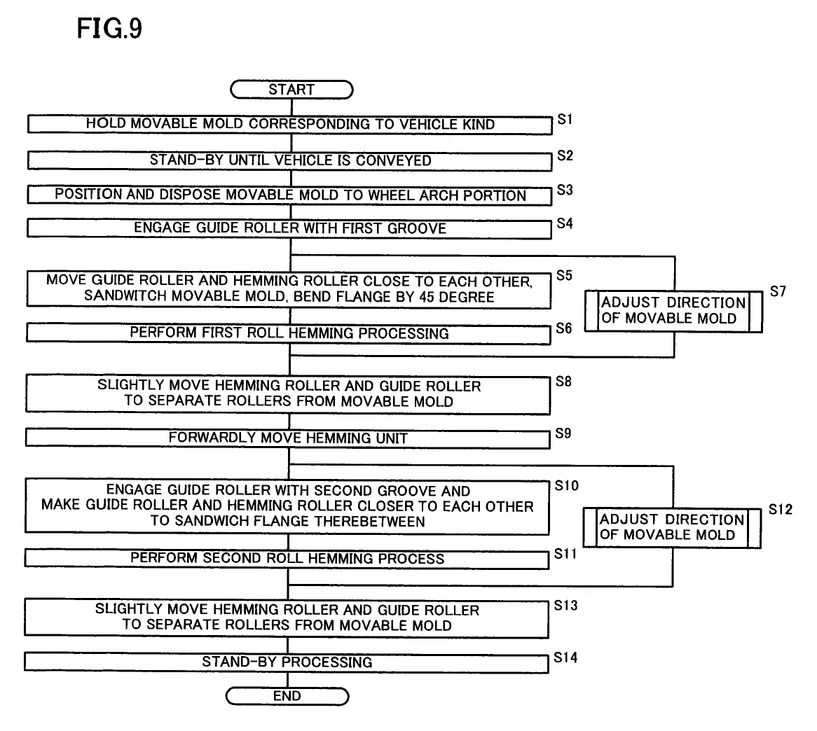

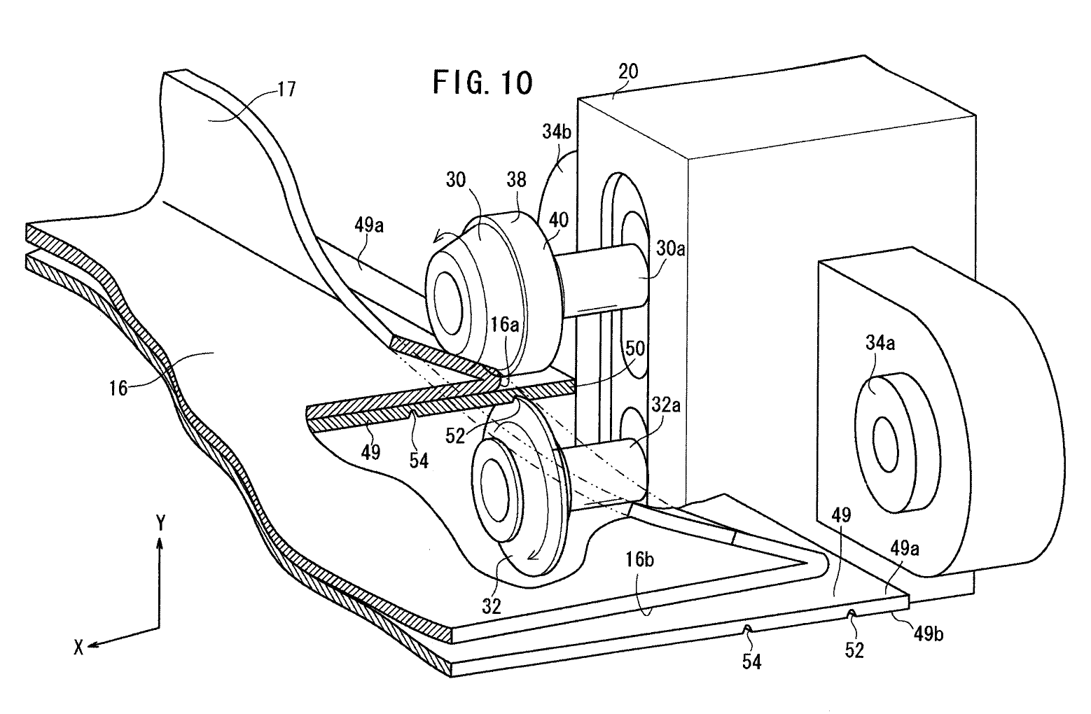

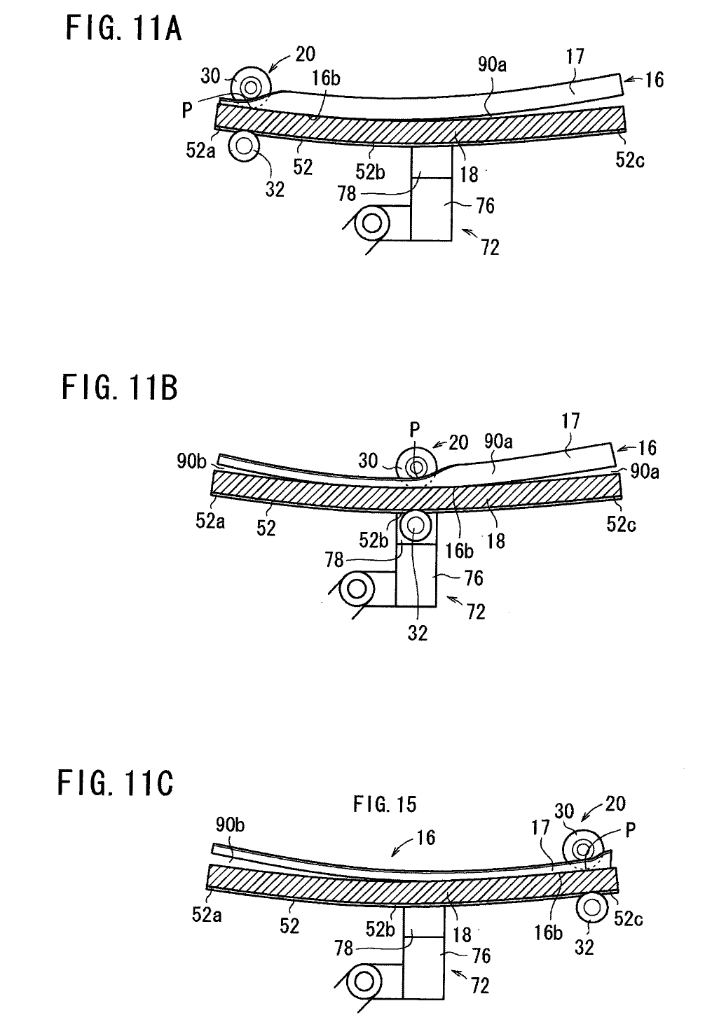

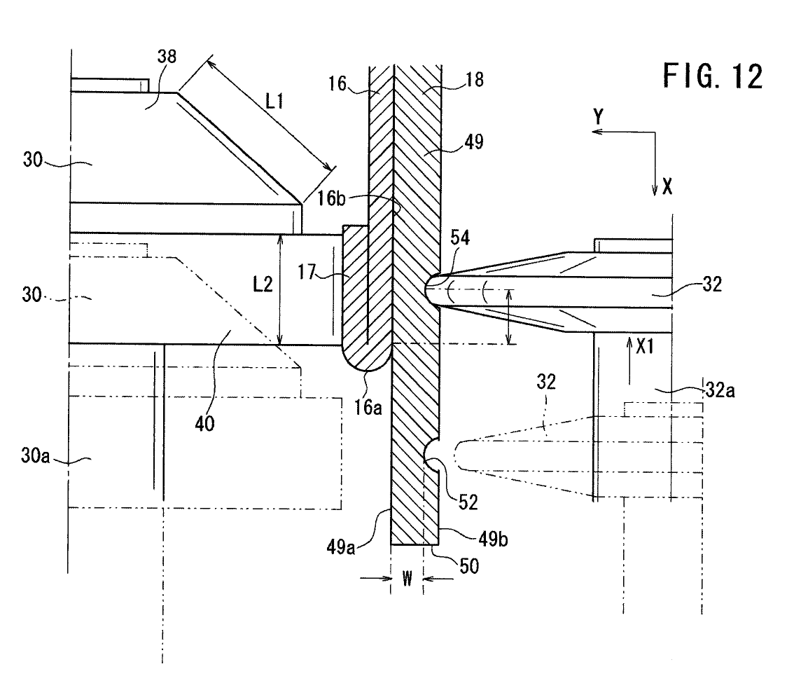

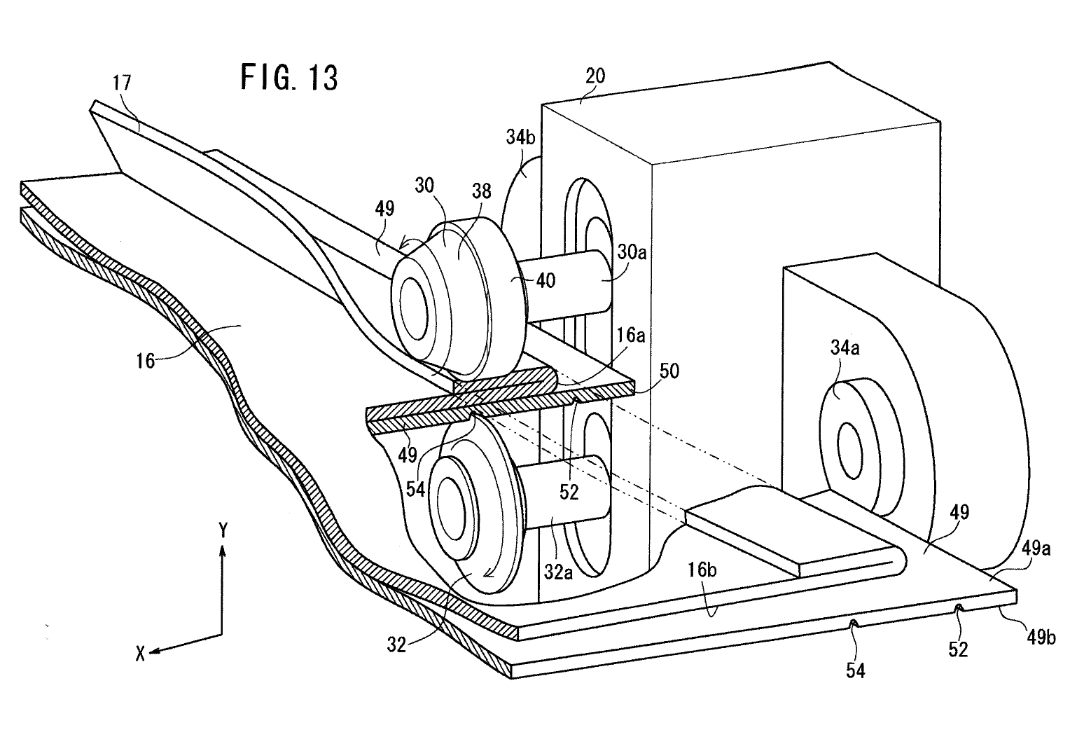

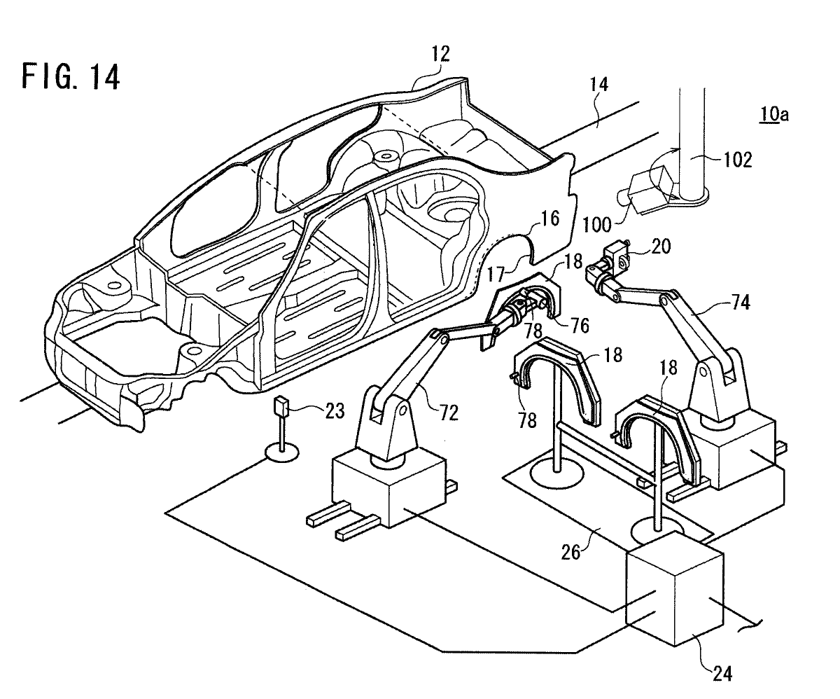

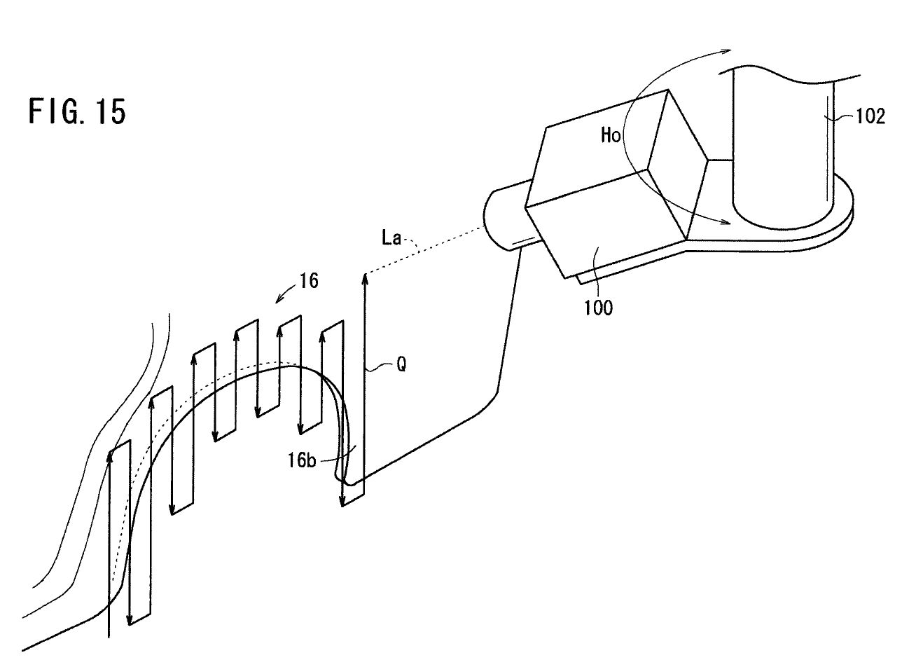

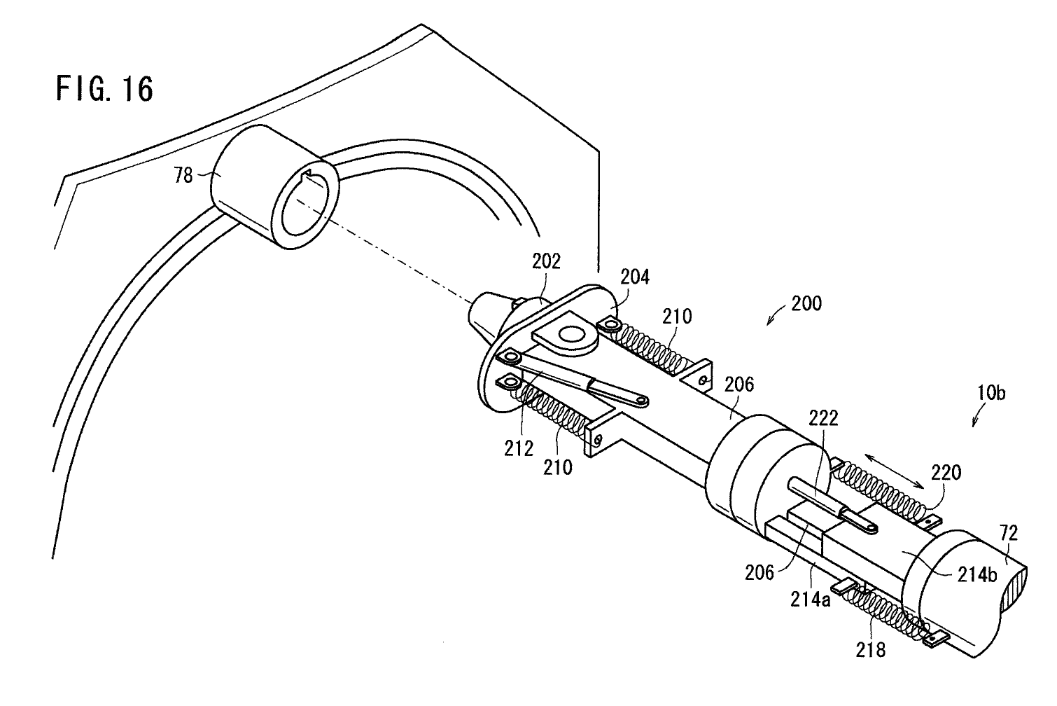

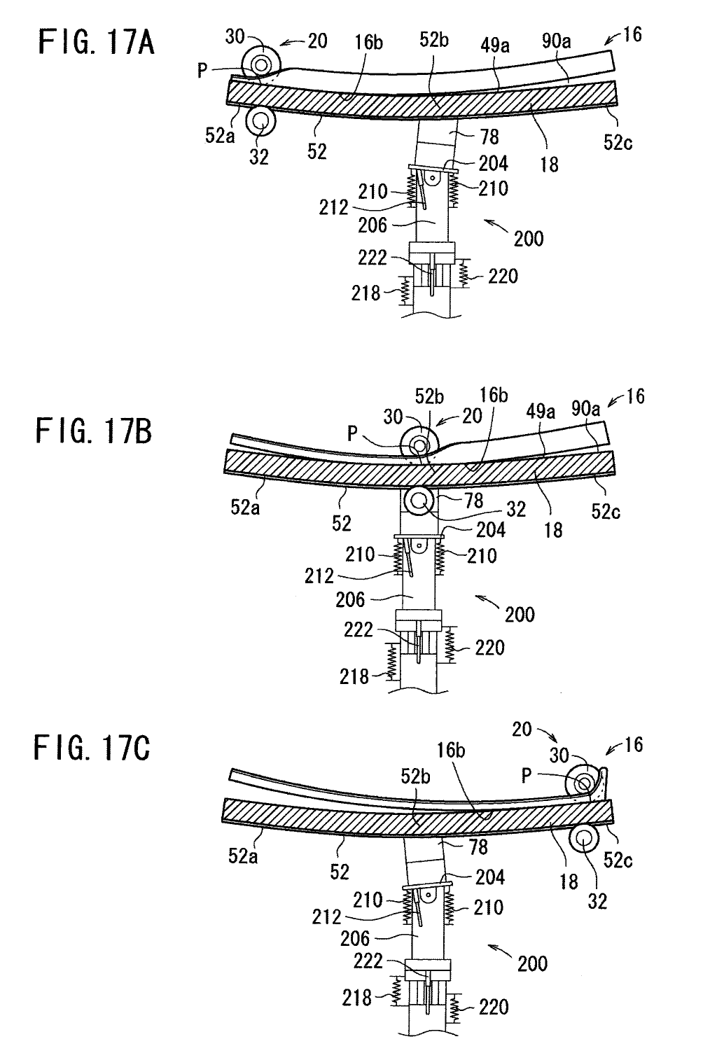

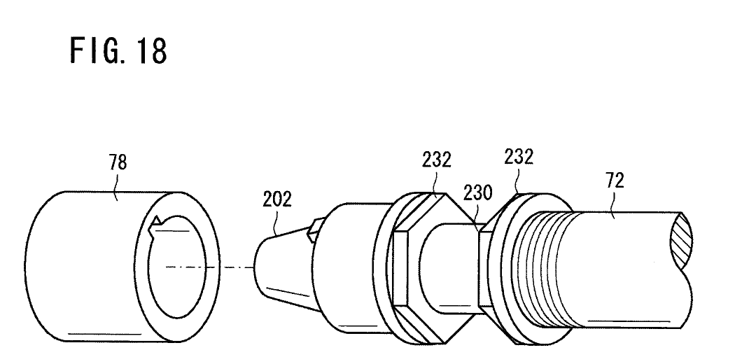

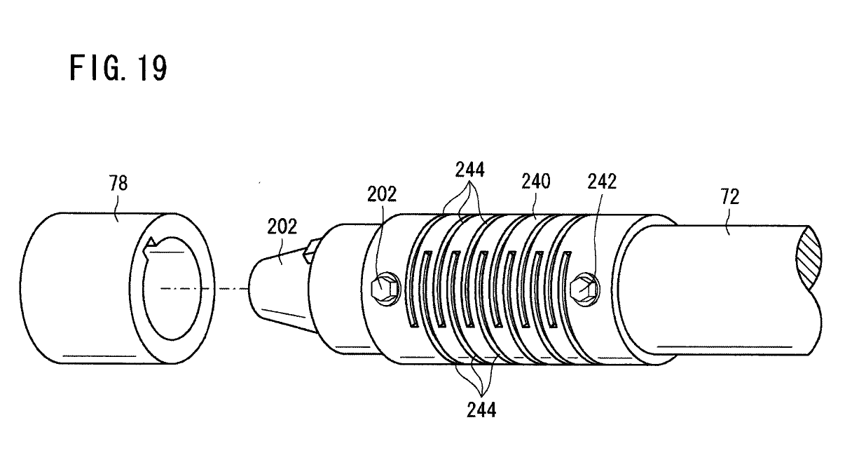

### BRIEF DESCRIPTION OF THE DRAWINGS

[FIG. 1] A perspective view of a hemming processing apparatus according to the first embodiment.

[FIG. 2] A perspective view of a movable mold fixed to a wheel arch portion.

[FIG. 3] A sectional plan view of the movable mold corresponding to a work of a convex shape.

[FIG. 4] A sectional plan view of the movable mold corresponding to a work of a concave shape.

[FIG. 5] A perspective view showing a hemming unit provided at the tip end of a robot in the hemming processing apparatus according to the first embodiment.

[FIG. 6] A diagram showing an image imaged by two cameras.

[FIG. 7] A sectional plan view of the movable mold fixed to the wheel arch portion.

[FIG. 8] An enlarged sectional view seen along a line VIII-VIII from arrowed direction in FIG. 7.

[FIG. 9] A flowchart showing the procedure of the hemming processing method according to the hemming processing apparatus according to the first embodiment.

[FIG. 10] A partially-broken perspective view showing a work, a hemming roller and a guide roller in the case of performing the first hemming process.

[FIG. 11] FIG. 11A is a typical sectional diagram developed along a first groove as to a state where one end portion of a flange is processed in the first embodiment, FIG. 11B is a typical sectional diagram developed along the first groove as to a state where the center portion of the flange is processed in the first embodiment, and FIG. 11C is a typical sectional diagram developed along the first groove as to a state where the other end portion of the flange is processed in the first embodiment.

[FIG. 12] A sectional diagram showing the positions of the hemming roller, the guide roller, the flange and the movable mold in the case of performing the second hemming process.

[FIG. 13] A partially-broken perspective view showing the work, the hemming roller and the guide roller in the case of performing the second hemming process.

[FIG. 14] A perspective view of showing the hemming processing apparatus having a three-dimensional meter.

[FIG. 15] A typical diagram showing a process for measuring the three-dimensional shape of the wheel arch portion by the three-dimensional meter.

[FIG. 16] A perspective view of a floating mechanism.

[FIG. 17] FIG. 17A is a typical sectional diagram developed along the first groove as to a state where one end portion of the flange is processed in the second embodiment, FIG. 17B is a typical sectional diagram developed along the first groove as to a state where the center portion of the flange is processed in the second embodiment, and FIG. 17C is a typical sectional diagram developed along the first groove as to a state where the other end portion of the flange is processed in the second embodiment.

[FIG. 18] An enlarged perspective view of a mold robot having an elastic member at the tip end portion thereof.

[FIG.19] An enlarged perspective view of a mold robot having a coupling at the tip end portion thereof.

### DETAILED DESCRIPTION OF THE EXEMPLARY EMBODIMENTS

Hereinafter, the hemming processing method and the hemming processing apparatus according to the invention will be explained as to some exemplary embodiments with reference to attached FIGS. 1 to 19.

Each of a hemming processing apparatus 10a according to the first embodiment and a hemming processing apparatus 10b according to the second embodiment is set on the way of a production line 14 for assembling and processing a vehicle (work) 12 in a so-called white body state and performs a roll hemming processing a to the flange 17 of a wheel arch portion 16 on a left rear wheel side. The wheel arch portion 16 has an arc shape of almost 180 degree. In a state before the processings performed by the hemming processing apparatus 10a and the hemming processing apparatus 10b, the flange 17 is bent by 90 degree inwardly from the end portion 16a (see a two-dot chain line in FIG. 8) of the wheel arch portion 16.

As shown in FIG. 1, the hemming processing apparatus 10a according to the first embodiment includes a movable mold 18 being made in contact with the wheel arch portion 16 of the vehicle 12 as the work, a processing robot (a roller moving apparatus) 74 having a hemming unit 20 at the tip end thereof, a photoelectric sensor 23 which detects that the vehicle 12 is transferred and positioned at a predetermined position (station) of the production line 14, a mold robot (a mold moving apparatus) 72 for moving the movable mold 18, and a controller 24 for performing the entire control.

As shown in FIG. 2, the mold robot 72 is provided at the tip end thereof with a mold support mechanism 76 for engaging with the chuck portion 78 of the movable mold 18. The mold support mechanism 76 is accurately positioned by a predetermined chuck mechanism with respect to the chuck portion 78 and negated therewith. The chuck portion 78 is provided at the center of the upper portion of the movable mold 18 or at the lower end portion etc. of the movable mold as shown by a phantom line. When the chuck portion 78 is provided at the center of the upper portion of the movable mold 18, the weight balance of the movable mold becomes good. Further, since the operation of the mold robot 72 at the time of performing the hemming processing becomes almost symmetric between the former half and the latter half, the operation balance becomes good. Furthermore, since the chuck portion is held near the tip portion of the wheel arch portion 16, the chuck portion can be positioned with respect to the tip portion with a high accuracy.

As shown in FIG. 3, the movable mold 18 is formed in a manner that the major surface 49a thereof serving as a surface abutting against the wheel arch portion 16 forms gaps at both ends thereof as compared with the surface 16b of the wheel arch portion 16, whereby the movable mold abuts against the surface 16b of the wheel arch portion 16 thereby to support a rolling portion P for the hemming processing.

When the surface 16b of the wheel arch portion 16 has a convex shape, the major surface 49a serving as the abutment surface of the movable mold 18 is formed as a surface having a gentle slope which curvature is slightly smaller than that of the surface 16b of the wheel arch portion 16. As shown in FIG. 4, when the surface 16b of the wheel arch portion 16 has a concave shape or a flat shape, the major surface 49a serving as the abutment surface of the movable mold 18 is formed as a surface which curvature is slightly larger than that of the surface 16b of the wheel arch portion 16.

The shape of the major surface 49a serving as the abutment surface of the movable mold 18 and the shape of the surface 16b of the wheel arch portion 16 are stored in the controller 24.

Referring to FIG. 1, each of the mold robot 72 and the processing robot 74 is a stationary industrial multi-joint robot and the tip end thereof can be moved to an arbitrary position and take an arbitrary posture by the programming operation.

A housing table 26, in which plural kinds of molds 18 are housed according to the kind of the vehicle 12, is provide near the mold robot 72 and in an operation range of the mold robot 72. The positional data of the housing table 26 is stored in the controller 24. The controller 24 is coupled to an external production management computer (not shown) for performing the operation control of the production line 14, whereby information representing the kinds etc. of the vehicles 12 conveyed on the production line 14 is supplied to the controller 24. Since the movable mold 18 has a small size, a plurality of the movable molds can be disposed within the operation range of the robot 24. The movable mold 18 is light-weighted and so easily transferred. The mold robot 72 is sufficient so long as it is a small-sized and small-output type.

The controller 24 controls the processing robot 74 in a manner that the work is sandwiched by the movable mold 18 and the roller and the flange 17 is bent while rolling the hemming roller with respect to the flange. Simultaneously, the controller 24 controls the mold robot 72 in a real time manner based on the rolling portion P of the guide roller 32and the hemming roller 30 (see FIG. 5) thereby to adjust the direction of the movable mold 18 so that the movable mold 18 supports the work.

As shown in FIG. 5, the hemming unit 20 includes the hemming roller 30 and the guide roller 32 provided so as to protrude from the end surface thereof and cameras (sensors) 34a and 34b provided at the left and right sides thereof. The cameras 34a and 34b are directed almost in the X-axis direction and so can continuously image a portion near the rolling portion by the hemming roller 30 and the guide roller 32. Images obtained by the cameras 34a and 34b are supplied to the controller 24. The controller 24 controls the posture of the mold robot 72 based on images 36a and 36b (see FIG. 6) supplied from the cameras 34a and 34b.

As shown in FIG. 6, the images 36a and 36b contain images of the wheel arch portion 16, the movable mold 18, the hemming roller 30 and the guide roller 32. In FIG. 6, the actual images 36a and 36b are shown in an adjacent manner so as to facilitating the understanding.

The hemming roller 30 and the guide roller 32 are supported by support shafts 30a and 32a so as to be rotatable freely, respectively. The hemming roller 30 and the guide roller 32 are movable in the Y-axis direction (the direction along which the support shafts 30a and 32a are disposed) so as to be able to adjust a space between the support shaft 30a and the support shaft 32a, whereby a pressure can be applied to a member sandwiched between the hemming roller 30 and the guide roller 32.

Further, each of the hemming roller 30 and the guide roller 32 has a so-called floating structure and so the hemming roller and the guide roller are movable in the X-axis direction (the axial directions of the support shafts 30a and 32a, respectively. That is, the hemming roller 30 and the guide roller 32 are movable in the X- axis and Y-axis directions (that is, in an X Y plane orthogonal to the rolling direction) while maintaining the relative position therebetween and move elastically and in a following manner in response to an external force. In other words, the support shafts 30a and 32a are movable in an interlocked manner to the X- axis and Y-axis directions while maintaining the adjusted distance therebetween.

Since each of the hemming roller 30 and the guide roller 32 is movable in the X- axis and Y-axis directions in a floating manner with respect to the processing robot 74, even if there is an error in the shape of the work, the floating structure absorbs the error according to the teaching of the processing robot 74. Thus, the hemming roller 30 can guide along the flange accurately without deviating the guide roller 32 from a first groove 52 and a second groove 54 for guiding described later.

When the axial directions of the hemming roller 30 and the guide roller 32 are not in parallel to each other, the axial direction of the guide roller 32 may be set to the X-axis direction.

Further, the Y-axis direction may be set as a direction along which the hemming roller 30 and the guide roller 32 are opposed. Alternatively, the Y-axis direction may be set so as to coincide with the pressing direction by a pressure source coupled to the hemming roller 30 and/or the guide roller 32.

The floating direction includes at least the X-axis and Y-axis directions and may further include at least one direction not in parallel to the X- axis and Y-axis directions.

Furthermore, when each of the hemming roller 30 and the guide roller 32 has the floating structure, the hemming roller 30 can preferably trace the flange 17 more accurately. However, even if only the guide roller 32 is configured to have the floating structure, the hemming roller can accurately trace the flange 17 sufficiently. Further, in this case, the configuration of the hemming unit 20 an be simplified.

The hemming roller 30 is configured by a tapered roller 38 provided at the tip end side thereof and a cylindrical roller 40 which is integrally provided with the tapered roller 38 and provided at the base end side thereof. The tapered roller 38 has a truncated cone shape which is inclined with an inclination angle of 45 degree so as to be thinner toward the tip end thereof, when seen from the side surface side. The length L1 of the ridge line of the tapered roller is set to be slightly longer than the height H of the flange 17. The cylindrical roller 40 has a cylindrical shape which diameter is slightly larger than the maximum diameter portion on the base end side of the tapered roller 38. The axial height L2 of the cylindrical roller is set to be slightly smaller than the height H of the flange 17.

The guide roller 32 has a disc shape in which the peripheral portion has a narrow width. The guide roller is able to engage with the first groove (first guide groove) 52 or the second groove (second guide groove) 54 (see FIG. 8) provided at the movable mold 18. The position of the guide roller 32 along the X-axis direction coincides with the center position of (L2/2) of the height L2 of the cylindrical roller 40 of the hemming roller 30 (see FIG. 8).

As shown in FIG. 7, the movable mold 18 is configured based on a mold plate 49. The mold plate 49 has a plate shape and one surface thereof contacting with the wheel arch portion 16 is called as the major surface 49a (see FIG. 8) and the other surface thereof on the opposite side of the major surface is called as a rear surface 49b. The work side of the wheel arch portion 16 when seen from the wheel arch portion 16b is called as an inner side and the opposite side thereof is called as an outer side. Unlike the example shown in FIG. 2, FIG. 7 shows an example where the chuck portion 78 is provided at the left lower portion of the movable mold 18 in order to clearly show the hemming unit 20.

The mold plate 49 is a plate of an arch shape which major surface 49a abuts against the periphery of the wheel arch portion 16. The major surface 49a is set to have a three-dimensional curvature so as to fit to the surface shape of the vehicle 12. Thus, when the movable mold 18 is attached to the wheel arch portion 16, the first groove 52 and the second groove 54 are disposed in parallel (or almost in parallel) to the flange 17 ands the major surface 49a is made in contact at its large area with the vehicle 12.

The movable mold 18 includes an outer arc portion 50 formed along slightly outside of the end portion 16a of the wheel arch portion 16 and the first groove 52 and the second groove 54 provided on the rear surface 49b so as to be in parallel to each other along the outer arc portion 50. The first groove 52 is provided on the outer surface of the extended portion of the mold plate 49 protruded from the end portion 16a of the flange 17 and the second groove 54 is provided at the inner side portion than the end portion 16a on the outer surface of the mold plate.

The movable mold 18 is small since it abuts only against the periphery of the wheel arch portion 16. Further, since the movable mold abuts against the side surface with respect to the vehicle 12, the weight of the vehicle 12 is not applied to the movable mold. Thus, the movable mold is set to have a small weight since the movable mold is not required to have a load withstand structure. Therefore, the movable mold 18 can be moved easily by the mold robot 72 when the chuck portion 78 is held by the mold support mechanism 76.

Next, the explanation will be made with reference to FIG. 9 as to the processing method in which the flange 17 of the wheel arch portion 16 is subjected to the roll hemming process by using the hemming processing apparatus 10a configured in this manner. The processing shown in FIG. 9 is executed by the movable mold 18, the hemming unit 20, the processing robot 74 and the mold robot 72 under the control of the controller 24 mainly.

First, in step S1, after confirming the information of the vehicle kind of a vehicle 12 conveyed next from the production management computer, the mold robot 72 returns the currently-held movable mold 18 to the prescribed position of the housing table 26 and holds another movable mold 18 corresponding to the vehicle kind of the next vehicle by the mold support mechanism 76. When the movable mold 18 corresponding to the vehicle kind of the next vehicle has been held already, the changing operation of the movable mold is not necessary. Further, when a plurality of vehicles 12 of the same vehicle kind are conveyed continuously, of course it is not necessary to change the movable mold 18.

In step S2, the operation is in a stand-by mode until the vehicle 12 is conveyed by confirming the signal from the photoelectric sensor 23. The next vehicle 12 is conveyed by the production line 14 and stops at a predetermined position near the processing robot 74. The process returns to step S3 when the arrival of the next vehicle 12 is confirmed by the photoelectric sensor 23.

In step S3, the processing robot 74 is operated to dispose the major surface 49a of the movable mold 18 at a position sufficiently near the wheel arch portion 16 of the vehicle 12. That is, in step S3, since the vehicle 12 having a large size and a large weight is stopped completely and the movable mold 18 having a small size and a small weight is made close to the vehicle, the positioning operation can be made easily.

In step S4, the guide roller 32 is made close to the outer arc portion 50 of the movable mold 18 and engaged with the first groove 52.

In step S5, the hemming roller 30 and the guide roller 32 are made close to each other, whereby the movable mold 18 is sandwiched between the guide roller 32 and the cylindrical roller 40 as shown in FIG. 8. In this case, the flange 17 is pressed by the tapered roller 38 and bent by 45 degree along the conical surface thereof. Further, as clear from FIG. 8, the distance between the guide roller 32 and the cylindrical roller 40 does not become close excessively since the distance is restricted to the width w between the bottom portion of the first groove 52 and the major surface 49a. Thus, the flange 17 is prevented from being bent by an angle larger than a prescribed angle or forming wave-shaped wrinkles. Further since the guide roller 32 and the cylindrical roller 40 are disposed in an opposite manner so that the positions thereof in the X-axis direction coincide to each other, the movable mold 18 can be surely sandwiched therebetween. Thus, the movable mold 18 is not applied with a moment force and so prevented from causing elastic deformation and deviation.

In step S6, as shown in FIG. 10, the guide roller 32 is rolled while engaging (following) the guide roller with the first groove 52 thereby to continuously perform the first hemming process in which the flange 17 is bent by 45 degree to the inside direction. In other words, the hemming roller 30 and the guide roller 32 perform the rolling operation while rotating in the opposite directions to each other to continuously bend the flange 17 along the conical surface of the tapered roller 38 thereby to perform the first hemming process. In this case, since each of the hemming roller 30 and the guide roller 32 has the floating structure, both the hemming roller and the guide roller can move in the X-axis and Y-axis directions while maintaining the relative position therebetween. Thus, even if there is a slight error in the operation locus of the processing robot 74, the guide roller 32 can move accurately along the first groove 52. Thus, the tapered roller 38 can press and deform the flange 17 in the prescribed direction. Further, since the operation accuracy of the processing robot 74 is not required to be quite high, the operation speed can be made high and the control procedure can be simplified. The hemming processing according to the first hemming process is performed over the entire length of the flange 17.

Further as clear from FIG. 10 (and FIG. 13), the first groove 52 (and the second groove 54) defines the position of the guide roller 32 in the Y-axis direction as well as the position thereof in the X-axis direction, whereby the guide roller can be positioned accurately. Since the hemming roller 30 is maintained in its relative position with respect to the guide roller 32, the hemming roller can be positioned accurately like the guide roller 32.

Step S7 is executed simultaneously in parallel to step S5 and next step S6. Step S5 and S6 mainly perform the control of the processing robot 74, whilst step S7 mainly performs the control of the mold robot 72 while synchronizing with the control of the processing robot 74. Step S7 is executed in a real time manner while step S5 and the next step S7 are executed.

In step S7, the controller 24 drives the mold robot 72 to adjust the direction of the movable mold 18 so that the movable mold 18 supports the surface 16b of the wheel arch portion 16 at the rolling portion P of the guide roller 32 and the hemming roller 30.

The posture of the mold robot 72 is set based on teaching data or is calculated and set based on the shape of the major surface 49a serving as the abutment surface of the movable mold 18 and the shape of the surface 16b of the wheel arch portion 16 stored in advance in accordance with the movement of the rolling portion P.

The wheel arch portion 16 may cause a warp due to the welding etc. and it is difficult to accurately predict such a warp in advance. However, since the many wheel arch portions 16 are all manufactured via the same welding process, the warps tend to occur almost in the same manner as to the many wheel arch portions. Thus, the three-dimensional shape of a predetermined sample of the wheel arch portion 16 may be measured and stored, and the operation of the mold robot 72 may be controlled in accordance with the measured shape.

Alternatively, an operation may be taught actually so as to perform the suitable operation as to the wheel arch portion 16, and the operation of the mold robot 72 may be controlled based on the teaching data.

To be concrete, first, as shown in FIG. 11A, the mold robot 72 is controlled in a manner that the end portion 52a abuts against the wheel arch portion 16 when the rolling portion P locates at the one end portion 52a of the major surface 49a of the movable mold 18. Thus, the major surface 49a abuts against the surface 16b without causing any gap therebetween at the one end portion 52a of the first groove 52 and so the flange 17 can be bent surely. In contrast, at the center portion 52b and the other end portion 52c of the first groove 52, there appears a gap 90a which size becomes larger in accordance with the distance from the one end portion 52a.

Next, as shown in FIG. 11B, when the rolling portion P reaches the center portion 52b, the mold robot 72 is controlled in a manner that the center portion 52b abuts against wheel arch portion 16. Thus, the major surface 49a abuts against the surface 16b without causing any gap therebetween at the center portion 52b and so the flange 17 can be bent surely. In contrast, there appear gap 90a and 90b at the end portion 52a and end portion 52c at the both sides of the first groove, respectively.

When the rolling is continued and the rolling portion P reaches the other end portion 52c as shown in FIG. 11C, the mold robot 72 is controlled in a manner that the end portion 52c abuts against the wheel arch portion 16. Thus, the major surface 49a abuts against the surface 16b without causing any gap therebetween at the other end portion 52c of the first groove 52 and so the flange 17 can be bent surely. In contrast, at the end portion 52a, there appears a gap 90a which size becomes larger in accordance with the distance from the end portion 52c.

In this manner, since the mold robot 72 adjusts the direction of the movable mold 18 so that the movable mold 18 supports the wheel arch portion 16 at the rolling portion P, only the rolling portion P abuts against the movable mold 18, so that the hemming portion is processed so as to be bent in a suitable shape and the warp and deformation of the work can be prevented.

Further, in step S7, the posture of the processing robot 74 may be controlled or corrected based on the images 36a and 36b (see FIG. 6) obtained from the cameras 34a and 34b, respectively.

That is, the controller 24 performs the image processing of the obtained images 36a and 36b and obtains, from the image 36a in the moving direction, a gap d1 between the movable mold 18 and the wheel arch portion 16 and an inclination angle θ1 between the movable mold 18 and the wheel arch portion 16 at a position away from the rolling portion P by a distance L in the moving direction.

The controller also obtains, from the image 36b on the backward side, a gap d2 between the movable mold 18 and the wheel arch portion 16 and an inclination angle 02 between the movable mold 18 and the wheel arch portion 16 at a position away from the rolling portion P by the distance L in the backward direction.

The controller controls the mold robot 72 to adjust the direction of the movable mold 18 in accordance with the gap d1, the gap d2 and (or) the inclination angle θ1 and the inclination angle θ2 thus obtained.

In this case, the controller 24 can detect the rolling portion P from the posture of the processing robot 74. Thus, as shown in FIG. 7, the posture of the mold robot 72 may be controlled in accordance with a predetermined coordinate calculation under a condition that a phantom arm 300 coupling between the chuck portion 78 and the rolling portion P is defined and the rolling portion P is supposed as the tip end portion of the mold robot 72.

The camera 34a or 34b may be provided as only one camera on the moving direction side. This is because the gap d2 and the inclination angle θ2 on the backward side can be estimated when the gap d1 and the inclination angle θ1 in the moving direction are measured and stored. Even when the moving direction is reversed, the similar processing can be performed so long as the gap d1 and the inclination angle θ1 are stored along the path.

Further, the adjustment can be performed with quite high accuracy even if only the gap d1 and the inclination angle θ1 in the moving direction are used without using the gap d2 and the inclination angle θ2 on the backward side.

In other words, since the shape of the major surface 49a which is the abutment surface of the movable mold 18 is stored in the controller 24 in advance, the position and the direction of the movable mold 18 at the rolling portion P can be suitably adjusted based on the gap d1, the inclination angle θ1 and the distance L.

In step S8, as shown by a two-dot chain line in FIG. 12, the distance between the hemming roller 30 and the guide roller 32 is made slightly larger to separate these rollers from the movable mold 18.

In step S9, the hemming unit 20 is moved in the forward direction thereby to forwardly move the hemming roller 30 and the guide roller 32 in an X1 direction shown by an arrow. The distance of this forward movement equals to the distance between the first groove 52 and the second groove 54.

In step S10, the guide roller 32 is engaged with the second groove 54. Further, the guide roller 32 and the hemming roller 30 are made closer to each other thereby to sandwich and presses the movable mold 18 between the guide roller 32 and the cylindrical roller 40, as shown in FIG. 12. In this manner, the operation procedure for moving the guide roller 32 from the first groove 52 to the second groove 54 is simple and the hemming unit 20 is merely required to be moved forwardly in the X1 direction shown by the arrow while maintaining the direction thereof. Further, since the moving distance is short, the movement can be completed in a short time.

Further, in this case, the flange 70 is pressed by the cylindrical roller 40 and bent until the flange contacts to the rear surface of the wheel arch portion 16. To be concrete, the flange 17 is further bent by 45 degree after the first hemming process, that is, 90 degree in total from the initial angle.

In step S11, as shown in FIG. 13, the guide roller 32 is rolled while engaging with (following along) the second groove 54 thereby to continuously perform a second hemming process in which the flange 17 is bent until the flange contacts to the rear surface of the wheel arch portion 16. In other words, the hemming roller 30 and the guide roller 32 roll while rotating in the opposite directions to each other, whereby the second hemming process is performed in a manner that the flange 17 is continuously bent by the outer cylindrical surface of the cylindrical roller 40.

Further, since the second groove 54 is provided on the rear surface 49b side of the mold plate 49, both the flange 17 and the mold plate 49 are sandwiched between the cylindrical roller 40 and the guide roller 32 and so surely pressed therebetween. Further, since the pressing force is not dispersed to other portions and there is no stopper for limiting the pressing force, the pressing force acts on the flange 17 concentrically. Thus, the flange 17 can be bent surely.

Like the first hemming process, in the second hemming process, the guide roller can move on the accurate path along the second groove 54 by the floating structure of the hemming roller 30 and the guide roller 32 thereby to perform the processing along the entire length of the flange 17.

Step S12 is executed simultaneously in parallel to step S10 and step S11. Step S12 is executed in a real time manner while step S10 and step S11 are executed. Since the processing of step S12 is same as that of step S7, the detailed explanation thereof is omitted.

In step S13, like step S8, the distance between the hemming roller 30 and the guide roller 32 is made slightly larger to separate these rollers from the movable mold 18. Further, the hemming unit 20 is temporarily separated from the movable mold 18.

In step S14, a stand-by processing is performed. That is, the processing robot 74 is moved to a predetermined stand-by position thereby to separate the movable mold 18 from the vehicle 12. The controller 24 notifies the production management computer that the hemming process normally completes. When the production management computer receives the notification, the production management computer confirms that the condition is satisfied also as to other predetermined requirements and drives the production line 14 thereby to convey the vehicle 12 having completed the hemming process to the next process.

In this manner, according to the hemming processing apparatus 10a, the movable mold can be abutted against the vehicle 12 conveyed on the production line 14 by using the small-sized and light-weighted movable mold 18 and then the hemming process can be performed. Thus, it is not necessary to provide a dedicated space for the hemming process. Further, since the hemming process is performed on the production line 14 like other assembling and processing processes, there does not arise such a troublesome work of conveying the vehicle 12 to the another dedicated space only for the hemming process and hence the productivity can be improved. Further, the hemming processing apparatus 10a can be applied to any size of a work since the process is performed by abutting the movable mold 18 against the processed portion of the work.

Since the movable mold 18 is small-sized and light-weighted, a plurality of the movable molds can be housed on the housing table 26 and so the keeping and the management of the movable molds can be facilitated. Further, since the processing robot 74 can select the movable mold 18 and perform the hemming process in accordance with the vehicle kind, the general-purpose properties can be enhanced.

Furthermore, since the hemming roller 30 can be commonly used for the first roll hemming and the second roll hemming, it is not necessary for changing the roller at the time of the roll hemming. Since each of the first groove 52 and the second groove 54 is provided on the rear surface 49b side, the flange 17 and the mold plate 49 can be sandwiched and pressed between the cylindrical roller 40 and the guide roller 32 in the second hemming process. These actions can also be obtained in the hemming processing apparatus 10b in the similar manner, as described later.

Further, since the first groove 52 and the second groove 54 for guiding the guide roller 32 is provided at the movable mold 18 and at least one of the hemming roller 30 and the guide roller 32 is supported so as to be movable in the axial direction, these rollers can be set to the suitable positions with respect to a work.

In the hemming processing apparatus 10a, although the cameras 34a and 34b are used as sensors for measuring the shape of the wheel arch portion 16, a three-dimensional meter 100 provided at a position slightly separated from the wheel arch portion 16 may be used in place of the cameras, as shown in FIG. 14.

As shown in FIG. 14, the three-dimensional meter 100 is provided at the lower end portion of a pole 102 extending downward from the sealing so as to be swingable automatically in the horizontally backward direction. The three-dimensional meter 100 is a laser scanner which scans in the vertical direction to detect the three-dimensional position of a subject in the scanning path.

As shown in FIG. 15, a laser light La is irradiated along a rectangular path Q on the subject while intermittently swinging the three-dimensional meter 100 in the horizontal direction Ho to measure the shape of the subject, whereby the three-dimensional shape of the wheel arch portion 16 can be detected.

By using the three-dimensional meter 100 thus configured, the three-dimensional shape of the wheel arch portion 16 can be measured as to each of the respective vehicles 12, whereby the mold robot 72 can be controlled suitably based on the detected measured data. Thus, the operations similar to those of FIGS. 11A to 11C can be realized, whereby the movable mold 18 can be surely abutted against the wheel arch portion 16, and so not only the hemming portion can be bent and formed in a suitable shape but also the warp and deformation of the wheel arch portion 16 can be prevented.

Next, the hemming processing apparatus 10b according to the second embodiment will be explained with reference to FIGS. 16 to 19. As to the hemming processing apparatus 10b, portions identical to those of the hemming processing apparatus 10a are referred to by the common symbols, with explanation thereof being omitted.

As shown in FIG. 19, a floating mechanism 200 is provided at the tip end of the mold robot 72 of the hemming processing apparatus 10b according to the second embodiment. The floating mechanism 200 corresponds to the mold support mechanism 76 and can hold the movable mold 18 so as to be movable freely.

The floating mechanism 200 includes a chuck mechanism 202 engaging with the chuck portion 78 of the movable mold 18, a first relay member 204 provided at the base end side of the chuck mechanism 202, a second relay member 206 pivotally supported so as to be able to incline in the horizontal direction with respect to the first relay member 204, and a slider 208 for holding the second relay member 206 so as to be slidable feely in the axial direction. The slider 208 is coupled to the tip end portion of the mold robot 72.

The first relay member 204 is coupled to the second relay member 206 by means of a pair of left and right coil springs 210. The first relay member is held at a neutral position when an external force is not applied thereto, whilst the first relay member is able to elastically incline in the left and right directions when an external force is applied thereto. A damper 212 is provided between the first relay member 204 and the second relay member 206, whereby the operation of the first relay member 204 is suitably suppressed and so stable.

The slider 208 is configured by a pair of slide member 214a and 214b and is smoothly slidable in the axial direction along a rail 216. The slide member 214a is fixed to the second relay member 206 and is provided with a coil spring 218 which is coupled to the tip end portion of the mold robot 72. The slide member 214b is fixed to the tip end portion of the mold robot 72 and is provided with a coil spring 220 which is coupled to the second relay member 206.

By the provision of the coil springs 218 and 220, the slider 208 is held at a neutral position when an external force is not applied thereto, whilst the slider is slidable in the axial direction elastically when an external force is applied thereto. A damper 222 is provided between the slide member 214a and the slide member 214b, whereby the operation of the slider is suitably suppressed and so stable.

Although the floating mechanism 200 is configured in a manner that the movable mold 18 can incline in the horizontal direction and slide in the axial direction, the floating mechanism may be movable in a direction other than these directions at the needs arises. For example, the floating mechanism may be configured so as to be movable elevationally.

Next, the explanation will be made as to the processing method in which the flange 17 of the wheel arch portion 16 is subjected to the roll hemming process by using the hemming processing apparatus la configured in this manner.

The roll hemming processing method using the hemming processing apparatus 10b is basically same as the procedure shown in FIG. 9 but differs therefrom in a point that the direction adjusting process of the movable mold 18 executed in steps S7 and S12 in FIG. 9 is not performed under the action of the controller 24. However, the direction adjusting process of the movable mold 18 is passively performed under the action of the floating mechanism 200.

That is, as shown in FIG. 17A, when the rolling portion P locates at the one end portion 52a of the major surface 49a of the movable mold 18, the guide roller 32 and the hemming roller 30 strongly attract to each other. Thus, the first relay member 204 of the floating mechanism 200 inclines slightly clockwise with respect to the second relay member 206 and the slider 208 is slightly pushed and shrunk. Thus, at the one end portion 52a of the first groove 52, the major surface 49a abuts against the surface 16b without causing any gap therebetween and so the flange 17 can be bent surely. In contrast, at the center portion 52b and the other end portion 52c of the first groove 52, there appears a gap 90a which size becomes larger in accordance with the distance from the one end portion 52a. In FIGS. 17A to 17C, the posture of the floating mechanism 200 is shown in an exaggerated manner so as to facilitate the understanding.

Next, as shown in FIG. 17B, when the rolling portion P reaches the center portion 52b, since the guide roller 32 and the hemming roller 30 strongly attract to each other, the first relay member 204 of the floating mechanism 200 locates at the neutral position with respect to the second relay member 206. Thus, the slider 208 slightly extends and the major surface 49a abuts against the surface 16b without causing any gap therebetween and so the flange 17 can be bent surely. In contrast, gaps 90b and 90c appear near the end portions 52a and 52c on the both sides.

When the rolling operation is further continued and the rolling portion P reaches the other end portion 52c as shown in FIG. 17C, the guide roller 32 and the hemming roller 30 strongly attract to each other. Thus, the first relay member 204 of the floating mechanism 200 inclines slightly counterclockwise with respect to the second relay member 206 and the slider 208 is slightly pushed and shrunk. Thus, at the other end portion 52c of the first groove 52, the major surface 49a abuts against the surface 16b without causing any gap therebetween and so the flange 17 can be bent surely. In contrast, at the end portion 52a, there appears a gap 90a which size becomes larger in accordance with the distance from the end portion 52c.

The mold robot 72 may be stopped while the hemming process is performed.

In this manner, since the floating mechanism 200 passively adjusts the direction of the movable mold 18 so that the movable mold 18 supports the wheel arch portion 16 at the rolling portion P, only the rolling portion P abuts against the movable mold 18, whereby the hemming portion is bent and processed in a suitable shape and further the warp and deformation of a work can be prevented.

In the hemming processing apparatus 10b thus configured, although the explanation is made as to a case where the floating mechanism 200 is provided at the tip end portion of the mold robot 72, an elastic member 230 may be provided as shown in FIG. 18. Alternatively, a coupling 240 may be provided as shown in FIG. 19.

As shown in FIG. 18, the elastic member 230 is provided at the tip end portion of the mold robot 72 and on the base end side than the chuck mechanism 202. The elastic member 230 has a cylindrical shape and is disposed at the tip end portion of the mold robot 72 so as to be coaxially with the chuck mechanism 202. The both ends of the elastic member are inserted into the mold robot 72 and the chuck mechanism 202 and fixed by fixing means (not shown) provided therein, respectively. The member 203 is formed by rubber, for example.

As shown in FIG. 19, the coupling 240 is provided at the tip end portion of the mold robot 72 and on the base end side than the chuck mechanism 202. The coupling 240 has a cylindrical shape and is disposed at the tip end portion of the mold robot 72 so as to be coaxially with the chuck mechanism 202. The both ends of the coupling are fixed by bolts 242 to the mold robot 72 and the chuck mechanism 202, respectively. The coupling 204 is a joint which can incline elastically in an arbitrary direction. The coupling is configured in a manner that, for example, a plurality of narrow grooves 244 are provided alternately so that the coupling inclines when the width of the grooves 244 changes in accordance with an external force applied thereto. The coupling 240 is also a kind of an elastic member.

By using the elastic member 230 and the coupling 240 etc., the movable mold 18 is held so as to be able to incline elastically and so placed in a so-called floating state. Thus, the operation similar to that shown in FIGS. 19A to 19C can be realized, whereby the movable mold 18 can be surely abutted against the wheel arch portion 16, and so not only the hemming portion can be bent and formed in a suitable shape but also the warp and deformation of the wheel arch portion 16 can be prevented.

As to each of the hemming processing apparatus 10a and the hemming processing apparatus 10b, although the explanation is made as to an example where the roll hemming process is made with respect to the wheel arch portion 16 of the left rear wheel of a vehicle 12, of course, the roll hemming process can also be applied to the wheel arch portion of the left side or other portions by setting the corresponding movable mold. A portion where the roll hemming process is applied may be a front wheel house edge portion, a door edge portion, a bonnet edge portion and a trunk edge portion, for example. The roll hemming process may be applied not only to the case of bending a sheet of thin plate but also to a case where the flange 17 is bent to sandwich the end portion of an inner panel as a thin plate provided separately, for example.

It will be apparent to those skilled in the art that various modifications and variations can be made to the described exemplary embodiments of the hemming processing method and the hemming processing apparatus according to the invention without departing from the spirit or scope of the invention. Thus, it is intended that the present invention cover all modifications and variations of this invention consistent with the scope of the appended claims and their equivalents.

### REFERENCE NUMERALS

10a, 10b hemming processing apparatus
12 vehicle (work)
14 production line
16 wheel arch portion
17 flange
18 movable mold
20 hemming unit
26 housing table
30 hemming roller
32 guide roller
38 tapered roller
40 cylindrical roller
49 mold plate
49a major surface
49b rear surface
50 outer arc portion
52 first groove
54 second groove
72 mold robot
74 processing robot

What is claimed is:

1. A hemming processing method comprising:
using a hemming roller for bending a flange of a work to perform a hemming process, a movable mold for supporting the work, and a mold moving apparatus for moving the movable mold; and
sandwiching the work between the hemming roller and the movable mold while adjusting a direction of the movable mold by the mold moving apparatus to perform the hemming process to the flange.

2. The hemming processing method according to claim 1, further comprising:
operating the mold moving apparatus in synchronous with a roller moving apparatus for moving the hemming roller to adjust the direction of the movable mold.

3. A hemming processing apparatus, comprising:
a hemming roller;
a roller moving apparatus for rolling the hemming roller on a flange of a work;
a movable mold for supporting the work; and
a mold moving apparatus for adjusting a direction of the movable mold in accordance with rolling of the hemming roller.

4. The hemming processing apparatus according to claim 3, wherein the mold moving apparatus holds the movable mold via an elastic member so that the direction of the movable mold is capable of being adjusted in accordance with rolling of the hemming roller.
